(19) United States
(12) Patent Application Publication
(10) Pub. No.: US 2010/0250631 A1
(43) Pub. Date: Sep. 30, 2010

(54) INFORMATION PROCESSOR, ELECTRONIC FILE MANAGING DEVICE, ELECTRONIC FILE MANAGING SYSTEM, AND COMPUTER READABLE MEDIUM

(75) Inventor: Shingo KAWAHARADA, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/547,137

(22) Filed: Aug. 25, 2009

(30) Foreign Application Priority Data
Mar. 27, 2009 (JP) 2009-078039

(51) Int. Cl. G06F 17/30

(52) U.S. Cl. 707/822; 707/E17.01; 707/E17.014

(57) ABSTRACT

An information processor is provided, the information processor including: a layered attribute obtaining unit that obtains layered attribute information related to a storing position where an electronic file is stored; and a transmitting unit that transmits the layered attribute information obtained by the layered attribute obtaining unit to an electronic file managing device together with the electronic file, the electronic file managing device managing the electronic file.

### CROSS-REFERENCE TO RELATED APPLICATIONS

This application is based on and claims priority under 35 U.S.C. 119 from Japanese Patent Application No. 2009-078039 filed Mar. 27, 2009.

### BACKGROUND

1. Technical Field

The present invention relates to an information processor, an electronic file managing device, an electronic file managing system and a computer readable medium.

2. Related Art

Ordinarily, various kinds of data of documents or drawings are systematically managed by folder layers. In this case, systematically arranged folder layers need to be previously prepared.

### SUMMARY

According to an aspect of the present invention, there is provided an information processor, including:

a layered attribute obtaining unit that obtains layered attribute information related to a storing position where an electronic file is stored; and

a transmitting unit that transmits the layered attribute information obtained by the layered attribute obtaining unit to an electronic file managing device together with the electronic file, the electronic file managing device managing the electronic file.

### BRIEF DESCRIPTION OF THE DRAWINGS

Exemplary embodiment of the present invention will be described in detail based on the following figures, wherein:

FIG. 1 is a diagram for explaining an information managing system according to this exemplary embodiment;

FIG. 2A is a block diagram of a hardware structure of a server device and a client device;

FIG. 2B is a diagram showing an example of attribute information to be managed;

FIG. 2C is a block diagram explaining a structural example of the client device;

FIG. 3 is a block diagram explaining a structural example of the server device;

FIG. 4 is a flowchart showing a program used when information is transmitted by using the client device;

FIG. 5 is a flowchart showing a program used when a provider of the information or a user of the information changes the storing position of the information by using the client device;

FIG. 6 is a flowchart showing a program used when the information is copied by using the client device;

FIG. 7 is a flowchart showing a program used when the information is searched by using the client device;

FIG. 8A is a flowchart showing a program that manages the information of an electronic file;

FIG. 8B is a flowchart showing a program that searches the information of the electronic file;

FIG. 9A is a diagram showing a specific example of layered attribute information;

FIG. 9B is a diagram showing an example of information that manages the electronic file in the server device;

FIG. 10 is a diagram for explaining positional information;

FIGS. 11A to 11E are diagrams showing specific examples of the layered attribute information;

FIG. 12 is a diagram showing a state of a screen obtained when the information is searched;

FIG. 13 is a diagram showing a display state obtained when a specific check box is selected;

FIG. 14 is a diagram showing a display state obtained when a node having a high relevancy is selected; and

FIG. 15 is a diagram showing a display state obtained when one is selected from a pull-down menu display.

### DETAILED DESCRIPTION

Now, a mode for carrying out the present invention (refer it to as an “exemplary embodiment”, hereinafter) will be described below. An explanation is given in a below-described order.
1. Electronic file managing system
2. Client device
3. Server device
4. Electronic file managing program
5. Specific example

### <1. Electronic File Managing System>

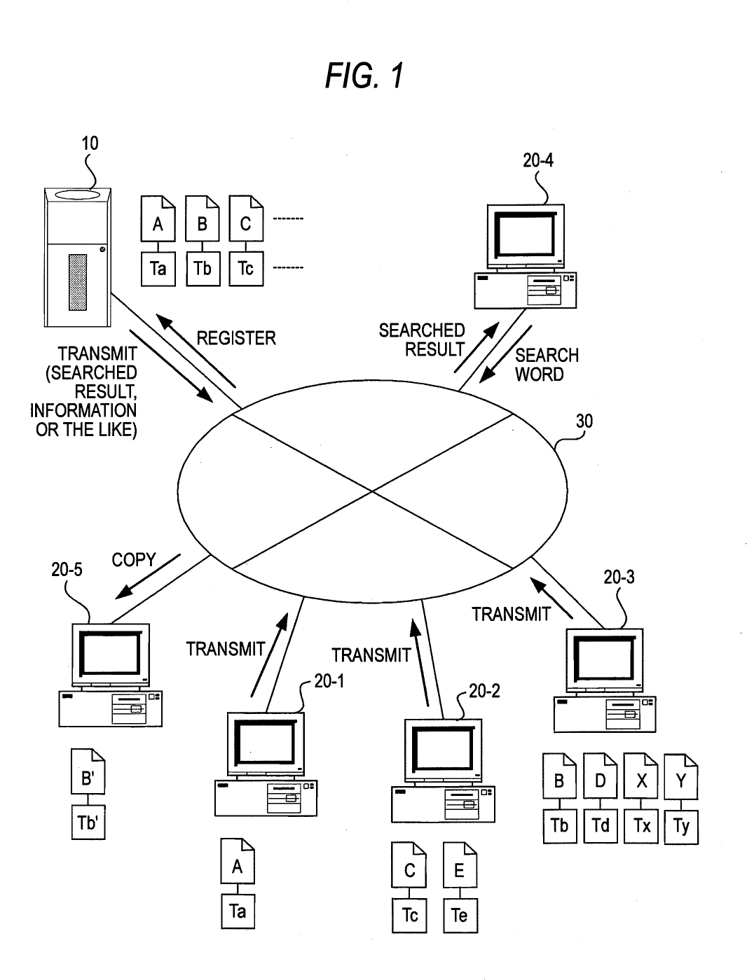

FIG. 1 is a diagram for explaining an electronic file managing system according to the present exemplary embodiment. Namely, in the electronic file managing system, a server device 10 as an electronic file managing device is connected to a client devices 20 as an information processor through a communication line 30. As the communication line 30, various kinds of lines such as an internet, an intranet, etc. are employed.

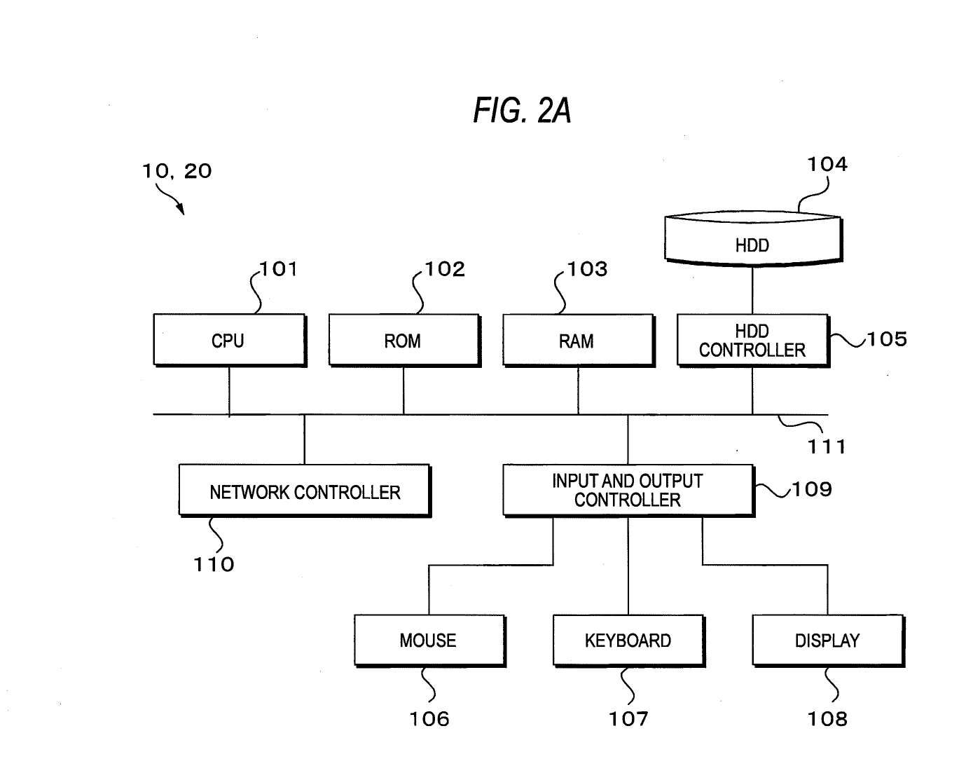

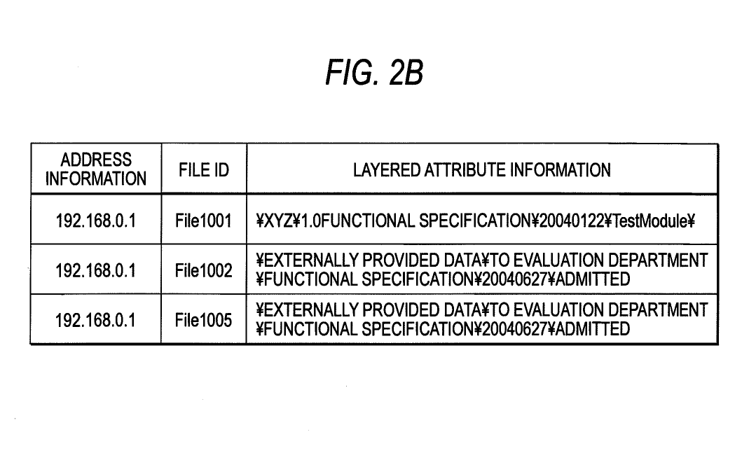

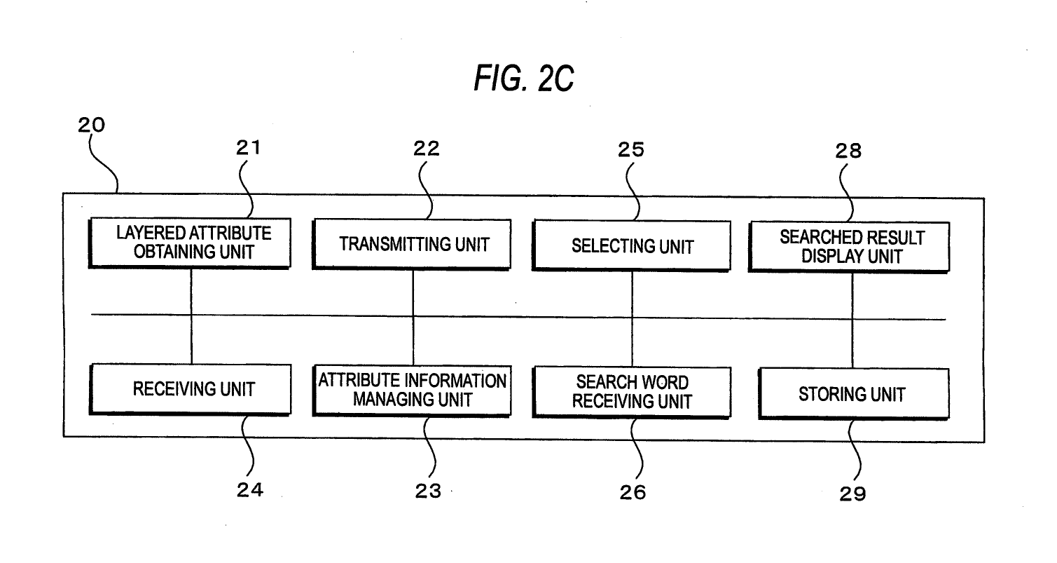

FIG. 2A is a block diagram for explaining a hardware structure of the server device and the client devices. In the hardware structure of the server device 10 and the client devices 20, a CPU (Central Processing Unit) 101, a RON (Read Only Memory) 102, a RAM (Random Access Memory) 103 an HDD (Hard Disk Drive) 104, an HDD controller 105, a mouse 106, a keyboard 107, a display 108, an input and output controller 109 and a network controller 110 are connected together by a bus 111.

A below-described electronic file managing program of this exemplary embodiment is stored in the HDD 104 of the above-described hardware structure, read by the RAM 103 and executed by the CPU 101 when the program is executed.

The server device 10 is provided with a storing unit for registering various kinds of electronic files transmitted from the client devices 20. Information registered in the storing unit is employed by the client devices 20 respectively connected through the communication line 30 as common information. That is, the common information registered in the server device 10 serves as an object to be searched and referred to by the client devices 20 respectively and is copied in the client devices 20 as required.

The electronic file mentioned herein means information represented by electronic data such as a document file, a drawing file, an image filer an installer of an application, etc.

Further when the server device 10 registers the electronic file, layered attribute information related to the storing position of the electronic file is coordinated with the electronic file to register the electronic file. Here, the layered attribute information indicates information of a position where the electronic file is stored in the client device 20 as a transmitter of the information, for instance, information of a folder layer in which the electronic file is stored or information of a path showing a position where the electronic file is stored. Further, the layered attribute information also includes information such as the name of a computer and an IP address of the client device.

Further, when the electronic file is copied to the client device 20 from the server device 10, information related to the storing position where the copied electronic file is stored is transmitted to the server device 10 as the layered attribute information to be coordinated with the electronic file in the server device 10 and registered. Namely, the layered attribute information indicates information showing the position where the electronic file transmitted and received between the client device 20 and the server device 10 is stored in the client device 20.

The server device 10 has a function that searches information corresponding to a request from the client device 20 in accordance with the layered attribute information coordinated with the registered electronic file. That is, the sever device 10 has a function that extracts the layered attribute information including a search word transmitted form the client device and transmits (returns) the extracted layered attribute information and the electronic file coordinated with the layered attribute information to the client device.

When the client device 20 registers the electronic file that is stored in the client device 20 in the serer device 10 as a shared object, each client device 20 has a function that transmits the electronic file to the server device 10 through the communication line 30. Further, when the client device 20 transmits the electronic file to the server device 10, the client device 20 also has a function that extracts the layered attribute information related to the storing position of the electronic file and transmitting the layered attribute information together with the electronic file to be transmitted.

Each client device 20 has a function that stores the copy of the electronic file registered in the server device 10 or a function that obtains the layered attribute information related to the storing position of the copied electronic file when the client device stores the copy of the electronic file and transmitting the layered attribute information to the server device 10.

When the client device 20 transmits the electronic file to and receives the electronic file from the server device 10, each client device 20 also has a function that manages the attribute information of the electronic file in the server device 10 of a transmitting and receiving side. When the layered attribute information of the electronic file transmitted and received between the client device 20 and the server device 10 is changed, the attribute information is used for informing about the contents of a change. In the following description, the attribute information is called electronic file attribute information. An example of the attribute information to be managed is shown in FIG. 2B. The electronic file attribute information is managed under a state that address information composed of an IP address of the server device 10, a file ID of the electronic file and the layered attribute information of the electronic file are coordinated together.

Further, each client device 20 has a function that receives the search word for searching the electronic file registered in the server device 10, transmitting the search word to the server device 10 and displaying a searched result returned from the server device 10.

Each client device 20 realizes the above-described various kinds of functions by, for instance, program processes of application software. Accordingly, only a part of the various kinds of functions is mounted or all the functions are mounted depending on the structure of the program processes of the application software. In order to easily understand an explanation in this exemplary embodiment, an example will be described below that all the functions are mounted on the client devices 20 respectively.

In a structural example of an information managing system shown in FIG. 1, the server device 10 is connected to five client devices 20-1 to 20-5 through the communication line 30. For instance, in the client device 20-1, an electronic file A is stored. In the client device 20-2, electronic files C and E are stored. In the client device 20-3, electronic files B, D, X and Y are stored. The client devices 20-1 to 20-3 respectively have functions for transmitting the electronic files stored in these devices to the server device 10 and registering the electronic files so as to be shared.

When the client devices 20-1 to 20-3 transmit the electronic files stored in these devices to the server device 10, the client devices 20-1 to 20-3 obtain layered attribute information related to the storing positions of the electronic files. That is, the client device 20-1 obtains the layered attribute information Ta of the electronic file A. Further, the client device 20-2 obtains the layered attribute information Tc and Te of the electronic files C and E. Further, the client device 20-3 obtains the layered attribute information Tb, Td, Tx and Ty of the electronic files B, D, X and Y.

When the client devices 20-1 to 20-3 transmit the electronic files stored in these devices to the server device 10, the client devices 20-1 to 20-3 transmit the obtained layered attribute information corresponding to the electronic files. That is, the client device 20-1 transmits the electronic file A and the layered attribute information Ta to the server device 10. Further, the client device 20-2 transmits the electronic files C and E and the layered attribute information Tc and Te respectively corresponding thereto to the server device 10. Further, the client device 20-3 transmits the electronic files B, D, X and Y and the layered attribute information Tb, Td, Tx and Ty respectively corresponding thereto to the server device 10.

The server device 10 stores the electronic files and the layered attribute information coordinated with the electronic files that are transmitted from the client devices 20-1 to 20-3 in the storing unit to manage the electronic files together with the coordination thereof.

The client device 20-4 receives the search word for searching the electronic file registered in the server device 10 and transmits the search word to the server device 10. Te server device 10 receives the search word transmitted from the client device 20-4 to extract the layered attribute information including the search word that is stored in the storing unit of the server device 10. Then, the server device 10 transmits (return) the searched result to the client device 20-4. The client device 20-4 displays the searched result returned from the server device 10.

The client device 20-5 has a function that stores the copy of the electronic file registered in the server device 10. For instance, the client device 20-5 downloads the electronic file B registered in the server device 10 through the communication line 30 and stores the copy in the device itself. Here, the copy of the electronic file B is referred to as an electronic file B′.

When the client device 20-5 stores the copy of the electronic file B and holds the electronic file B′ in the device itself, the client device 20-5 obtains layered attribute information Tb′ related to the storing position of the electronic file B′. Then, the client device 20-5 transmits the layered attribute information Tb′ of the electronic file B′ to the server device 10 as an original copy side. The server device 10 manages the layered attribute information Tb′ by coordinating the layered attribute information Tb′ with the electronic file B of an original copy.

### <2. Client Device>

FIG. 2C is a block diagram explaining a structural example of the client device. The client device 20 includes a layered attribute obtaining unit 21, a transmitting unit 22, an attribute information managing unit 23, a receiving unit 24, a selecting unit 25, a search word receiving unit 26 and a searched result display unit 28. These means are mainly realized by program processes. Further, the client device 20 includes a storing unit 29 for storing information.

The selecting unit 25 carries out a process for selecting the electronic file in the client device or the server device.

The layered attribute obtaining unit 21 obtains the layered attribute information corresponding to the electronic file transmitted and received between the server device and the client device.

The transmitting unit 22 carries out a process for transmitting the information to the server device. As one example of an operation, the transmitting unit 22 carries out the process for transmitting the electronic file in the client device selected by the selecting unit 25 and the layered attribute information corresponding to the electronic file obtained in the layered attribute obtaining unit 21 to the server device.

The receiving unit 24 carries out a process for receiving the information from the server device. As one example of an operation, the receiving unit 24 carries out the process for receiving the copy of the electronic file in the server device selected by the selecting unit 25. When the electronic file received by the receiving unit 24 is stored in the storing unit, a process is also carried out in which the layered attribute information related to the storing position of the stored electronic file is obtained by the layered attribute obtaining unit 21 and transmitted to the server device by the transmitting unit 22.

The attribute information managing unit 23 manages electronic file attribute information transmitted and received between the server device and the client device. When the layered attribute information of the electronic file recorded in the electronic file attribute information to be managed is changed, the attribute information managing unit 23 updates the changed layered attribute information and transmits the updated layered attribute information to the server device through the transmitting unit 22. The electronic file attribute information managed in the attribute information managing unit 23 includes address information of the server device communicated for each electronic file, a file ID, the layered attribute information of the electronic file, or the like. The file ID exclusively specifies the file and is outputted in the server device. An example of the file ID is shown in FIG. 2B.

When a user inputs the search word for searching the electronic file registered in the server device, the search word receiving unit 26 carries out a process for receiving the search word. The search word receiving unit 26 carries out a process for transmitting the search word received in the search word receiving unit 26 to the server device through the transmitting unit 22. The searched result display unit 28 carries out a process for displaying the searched result returned from the server device. The searched result includes the layered attribute information of information including the transmitted search word and the electronic file coordinated therewith or corresponding thereto.

### <3. Server Device>

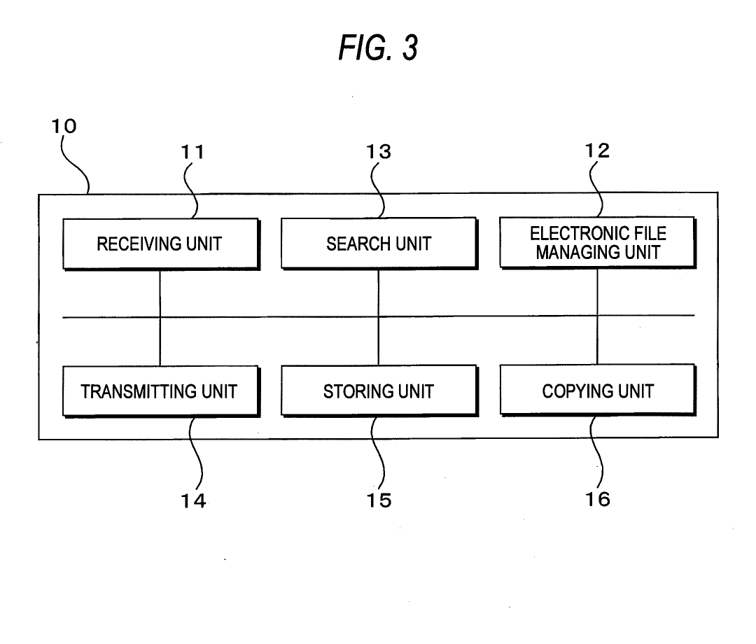

FIG. 3 is a block diagram explaining a structural example of the server device. The server device 10 includes a receiving unit 11, an electronic file managing unit 12, a search unit 13 and a transmitting unit 14. The above-described units are mainly realized by program processes. Further, the server device 10 includes a storing unit 15 for storing information and a copying unit 16 for copying the information.

The receiving unit 11 carries out a process for receiving the information transmitted from the client device. As one example of an operations the receiving unit carries out the process for receiving the electronic file transmitted from the client device and the layered attribute information related to the storing position of the electronic file. The electronic file managing unit 12 stores and manages the electronic file and the layered attribute information of the electronic file in the storing unit 15. The electronic file managing unit 12 carries out a process for coordinating the electronic file received by the receiving unit 11 with the layered attribute information of the electronic file and registering the electronic file and the layered attribute information in the storing unit 15.

When the search word received by the search word receiving unit 26 (see FIG. 2C) of the client device is transmitted, the search unit 13 carries out a process for searching whether or not the layered attribute information managed in the electronic file managing unit 12 has the layered attribute information including the search word.

The transmitting unit 14 carries out a process for transmitting the information to the client device. The transmitting unit 14 carries out the process for transmitting the result of a search by the search unit 13. As one example of an operation, when there is the layered attribute information including the search word, the transmitting unit 14 transmits the layered attribute information and the information of the electronic file coordinated with or corresponding to the layered attribute information to the client device. On the other hand, when there is no layered attribute information including the search word, the transmitting unit 14 transmits to the client device information to the effect that there is not layered attribute information including the search word.

### <4. Electronic File Managing Program>

### [Program Executed by Computer of Client Device]

(Program Used when Information Provider Transmits Information)

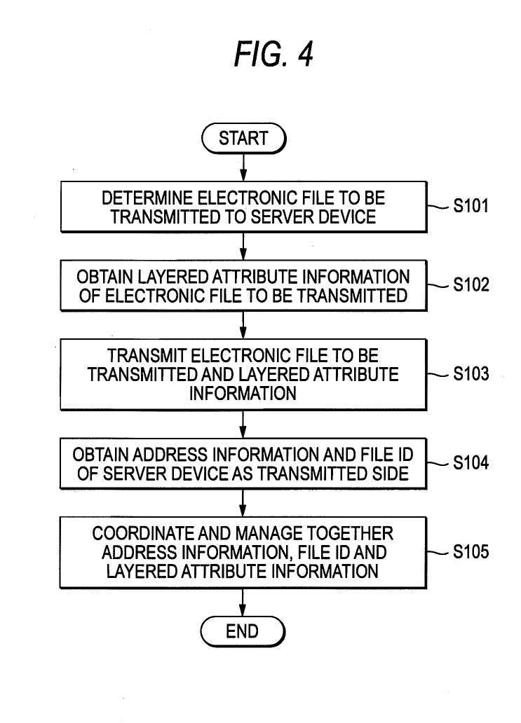

FIG. 4 is a flowchart showing a program employed when information is transmitted by using the client device. This program shows processes by a functional structure including the layered attribute obtaining unit 21, the transmitting unit 22, the selecting unit 25 and the attribute information managing unit 23 of the client device 20 shown in FIGS. 2A to 2C.

Initially, the client device determines the information to be transmitted to the server device by the selecting unit 25 (step S101) That is, the client device determines the electronic file to be transmitted in accordance with an instruction of an information provider.

Then, the client device obtains the layered attribute information related to the storing position of the electronic file to be transmitted (step S102). This process is carried out by the layered attribute obtaining unit 21.

Then, the client device carries out a process for transmitting the electronic file to be transmitted and the previously obtained layered attribute information to the server device (step S103). This process is carried out by the transmitting unit 22 shown in FIGS. 2A to 2C. A person who provides the electronic file by using the client device transmits not only the electronic file, but also the layered attribute information corresponding to the electronic file to the server device. Namely, the person who provides the electronic file does not need to do a special operation by himself or herself. Thus, in accordance with the transmission of the electronic file, the layered attribute information corresponding to the electronic file as an object to be searched is provided to the server device.

Subsequently, the client device carries out a process for obtaining address information of the server device to which the electronic file is transmitted and a file ID attached when the electronic file is registered (step S104). This process is carried out by the attribute information managing unit 23 shown in FIG. 2C That is, the attribute information managing unit 23 coordinates together the address information such as an IP address of the server device as a side to which the electronic file is transmitted and the file ID of the transmitted electronic file and the layered attribute information of the electronic file and manages the coordinated information (step S105).

(Program Used when Information Provider or User Changes Storing Position of Electronic File)

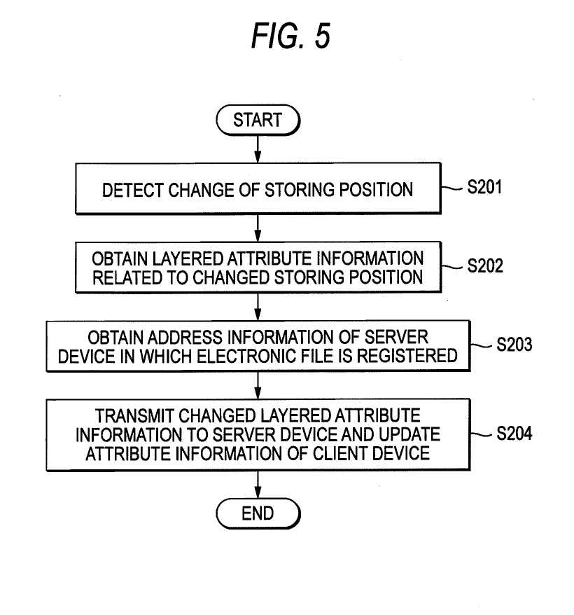

FIG. 5 is a flowchart showing a program used when an information provider or an information user changes the storing position of the electronic file by using the client device. This program shows processes by a functional structure including the layered attribute obtaining unit 21, the transmitting unit 22 and the attribute information managing unit 23 of the client device 20 shown in FIGS. 2A to 2C. Here, the information user means a user who copies the electronic file as described below.

Initially, when the user changes the storing position of the electronic file registered in the server device, the client device detects the occurrence of a change in accordance with the information managed by the attribute information managing unit 23 (step S201) The layered attribute obtaining unit 21 obtains layered attribute information related to a changed storing position (step S202).

Then, the client device carries out a process for obtaining the address information of the server device in which the electronic file whose storing position is changed is registered (step S203). This process is carried out by the attribute information managing unit 23 shown in FIGS. 2A to 2C.

Then, the client device carries out a process for transmitting the changed layered attribute information obtained in the step S202 to the server device based on the address information obtained in the step S203. Further, the client device updates the information managed in the attribute information managing unit 23 of the client device (step S204). A transmitting process to the server device is carried out by the transmitting unit 22 shown in FIG. 2C. The server device coordinates the newly transmitted layered attribute information with the registered information and manages the coordinated information. Thus, when the storing position of the information registered in the server device is changed in the client device, the changed new layered attribute information is coordinated with the registered information and managed. Whether the changed new layered attribute information is added to be managed or the information is updated is designated by a setting operation by the server device.

(Program Used when Information User Copies Electronic File)

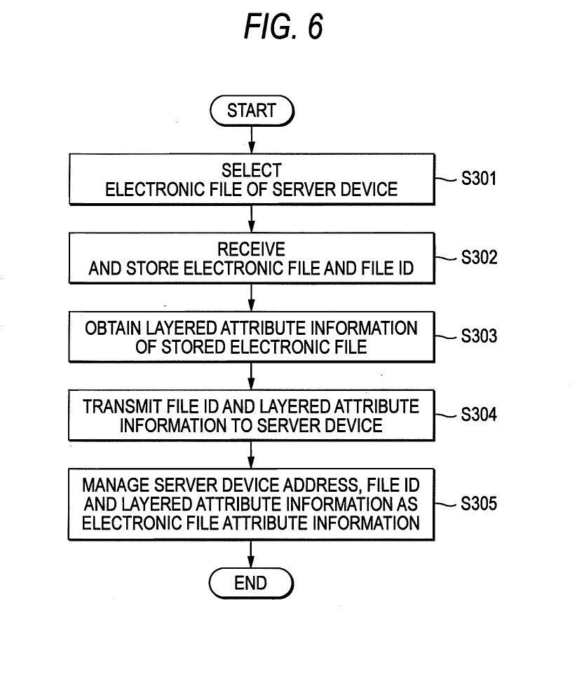

FIG. 6 is a flowchart showing a program used when the electronic file is copied by using the client device. This program shows processes by a functional structure including the receiving unit 24, the layered attribute obtaining unit 21 and the transmitting unit 22 of the client device 20 shown in FIGS. 2A to 2C.

Initially, the client device selects the electronic file to be copied from the server device in accordance with an instruction of the user (step S301). This process is carried out by the selecting unit 25 shown in FIGS. 2A to 2C.

Then, the client device receives the electronic file selected by the selecting unit 25 in the receiving unit 24 and stores the electronic file in the storing unit 29 of the client device. At this time, the receiving unit also receives the file ID for identifying the file (step S302).

The layered attribute information of the stored electronic file is obtained by the layered attribute obtaining unit 21 (step S303) and transmitted to the server device together with the file ID through the transmitting unit 22 (step S304).

Further, the attribute information managing unit 23 coordinates together the address information of the server device communicating with the receiving unit 24, the file ID and the layered attribute information obtained in the layered attribute obtaining unit 21 and manages the coordinated information in order to manage the information of the stored electronic file as electronic file attribute information (step S305).

In accordance with the processes, when the electronic file is copied, in the server device, the layered attribute information related to the storing position of the copied electronic file is managed under a state that the layered attribute information of the copied electronic file is coordinated with the electronic file to be copied. Namely, when the electronic file is copied, not only the layered attribute information corresponding to the original electronic file, but also the layered attribute information corresponding to the copied electronic file is managed under a coordinated state in the information of the electronic file to be copied.

(Program Used when Information User Searches Information)

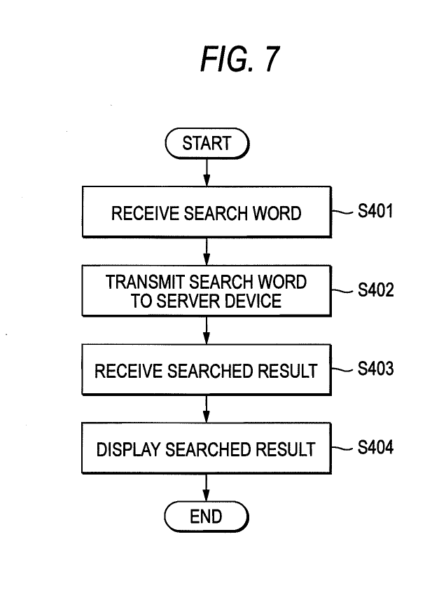

FIG. 7 is a flowchart showing a program used when the information is searched by using the client device. This program shows processes by a functional structure including the search word receiving unit 26, the transmitting unit 22, the receiving unit 24 and the searched result display unit 28 of the client device 20 shown in FIGS. 2A to 2C.

Initially, the client device receives a search word (step S401) This process is carried out by the search word receiving unit 26 shown in FIGS. 2A to 2C. The search word receiving unit 26 receives the search word inputted by the user.

Then, the client device carries out a process for transmitting the received search word to the server device (step S402). This process is carried out by the transmitting unit 22 shown in FIGS. 2A to 2C. The server device receiving the search word carries out a search based on the search word and returns a searched result to the client device as a transmitter of the search word.

The client device receives the searched result returned from the server device (step S403). Then, the client device carries out a process for displaying the received searched result (step S404). This process is carried out by the searched result display unit 28.

### [Program Executed by Computer of Server Device]

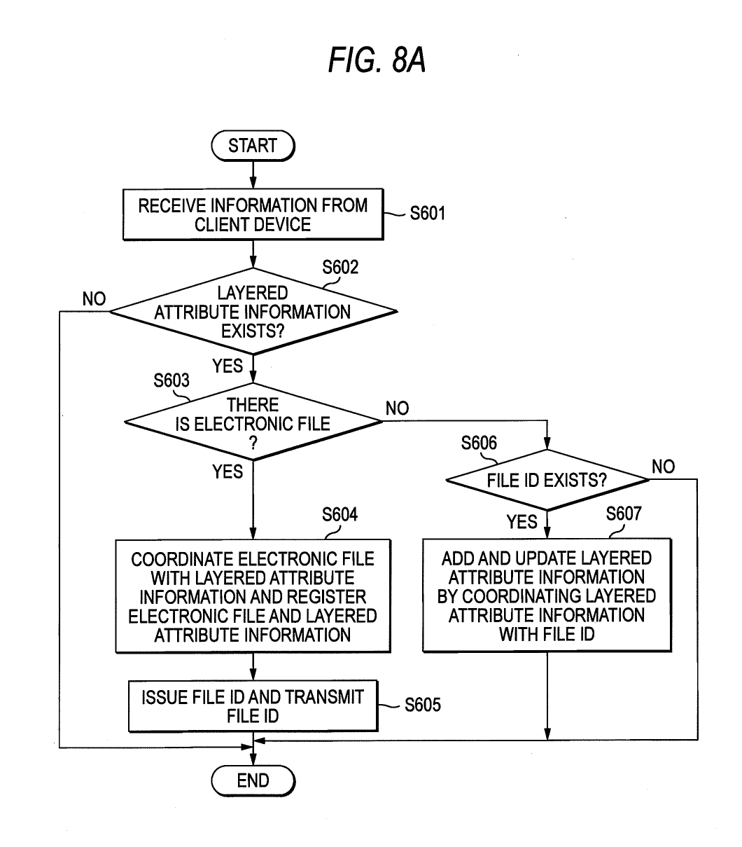

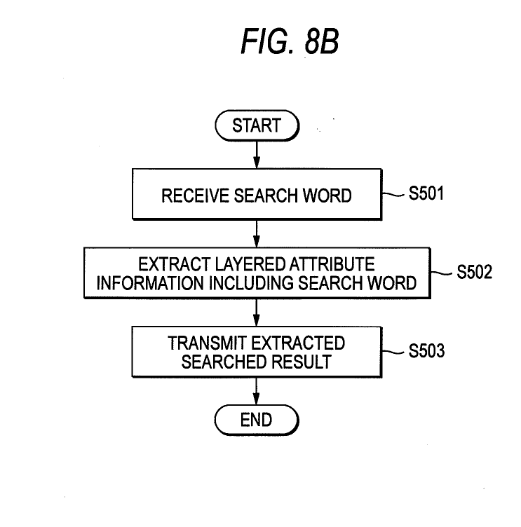

FIGS. 8A and 8B are flowcharts showing programs executed by the computer of the server device. The programs show processes carried out by the receiving unit 11, the electronic file managing unit 12, the search unit 13 transmitting unit 14 of the server device 10 shown in FIG. 3.

### (Flowchart for Managing Information of Electronic File)

FIG. 8A is a flowchart showing a program for managing the information of the electronic file. Initially, the server device receives the information from the client device (step S601). This process is carried out by the receiving unit 11 shown in FIG. 3.

Then, the electronic file managing unit 12 decides a type of process depending on the contents of the received information to carry out a process. When the received information has the layered attribute information (step S602) and the electronic file (step S603), the electronic file managing unit 12 coordinates the electronic file with the layered attribute information and registers the coordinated electronic file and layered attribute information in the storing unit 15 (step S604).

Further, when the server device registers the electronic file and the layered attribute information, the server device outputs the file ID and transmits the file ID to the client device 20 through the transmitting unit 14 (step S605). In the step S602, when there is no layered attribute information, the server device finishes the process. In the step S603, when there is no electronic file and there is the file ID (step S606), the server device adds or updates the layered attribute information corresponding to the file ID (step S607). In the step S606, when there is no file ID, the server device finishes the process. In the step 607, whether the layered attribute information is added or updated is decided by using information included in the layered attribute information. For instance, when the information of the computer name or the information of the IP address is the same, the sever device may decide to update the layered attribute information. When the information of the computer name or the information of the IP address is different, the server device may decide to add the layered attribute information. What decision is to be made may be designated by a setting operation of the server device.

### (Flowchart for Searching Information of Electronic File)

FIG. 8B is a flowchart showing a program for searching the information of the electronic file. The server device receives the search word sent from the client device by the receiving unit 11 (step S501). The server device carries out a process for extracting the layered attribute information including the search word by the search unit 13 (step S502).

The search unit 13 extracts the layered attribute information including the search word transmitted from the client device and the information of the electronic file coordinated with or corresponding to the layered attribute information from the layered attribute information stored in the storing unit 15 as an object to be searched.

When there is the layered attribute information including the search word, the searched result includes the layered attribute information and the information having the name and the storing position of the electronic file coordinated with or corresponding to the layered attribute information. On the other hand, when there is no layered attribute information including the search word, the searched result indicates information to the effect that there is no layered attribute information including the search word.

Then, the server device carries out a process for transmitting the searched result to the client device as the transmitter of the search word through the transmitting unit 14 (step S503). The client device carries out a display based on the transmitted searched result.

The above-described various kinds of programs include steps that are allowed to be executed by the computer, are stored in the ROM of the computer, recorded in a recording medium such as a CD-ROM or distributed through a network. Further, the computer includes a calculating part for executing the above-described programs, a storing part for storing the programs or various kinds of data and an input and output part. The computer may be incorporated in an electronic device for treating information such as a portable terminal as well as an electronic computer such as a personal computer.

### <5. Specific Example>

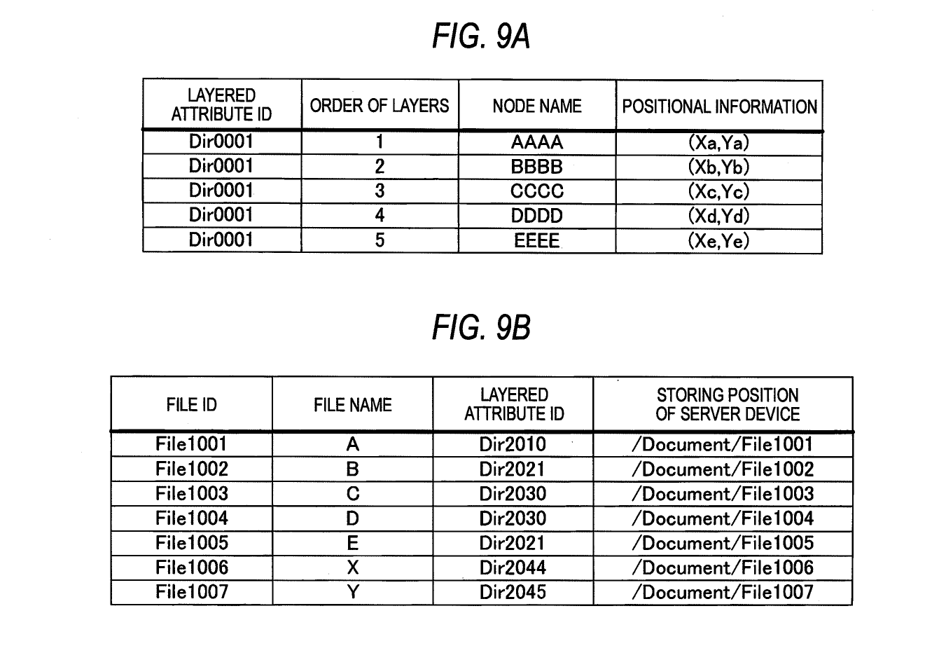

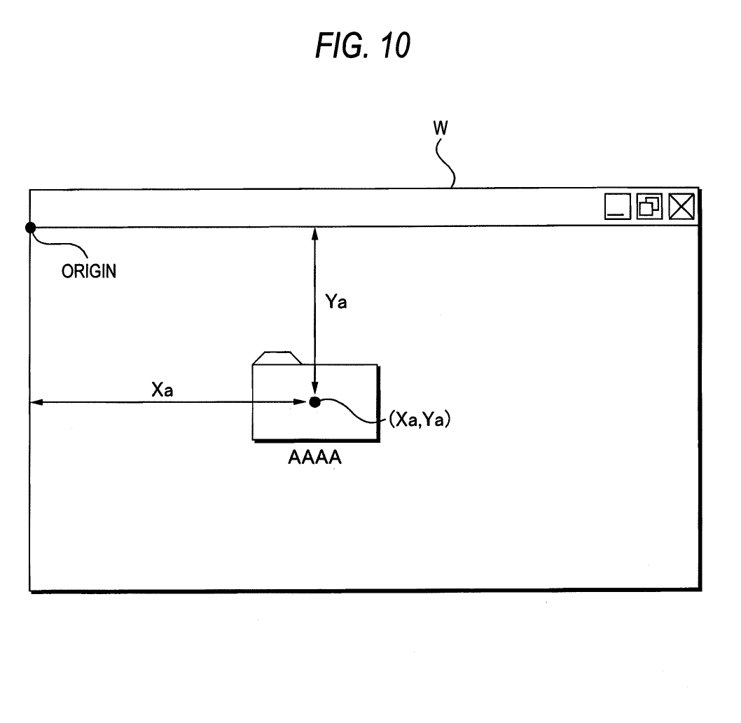

FIG. 9A is a diagram explaining a specific example of the layered attribute information. The layered attribute information is information transmitted from the client device and includes a layered attribute ID of a layered structure showing a position where the information is stored, a layer order, a node name, positional information in a window (a display frame) of a node.

The layered attribute ID is issued when the electronic file is registered in the server device and exclusively assigned for each layered structure. The layer order shows the upper and lower ranks of the layered structures. In this exemplary embodiment, since the positional information in the window (the display frame) of each node is also managed, such a structure as shown in FIG. 9A is employed. The node name includes a device name (a computer name), a drive name of a hard disk, the IP address of the client device or the like as required.

When the positional information in the window (the display frame) of each node is managed, in the client device side, the part of the layered attribute information in the attribute information of the electronic file of the client device shown in FIG. 2B is replaced by the layered attribute ID to manage the attribute information together with a form of the layered attribute information of FIG. 9A.

In an example shown in FIG. 9A, the node names are designated in order of upper layer to lower layer. For instance, the layered structure shown in FIGS. 9A and 9B include a structure of AAAA/BBBB/CCCC/DDDD/EEEE, as the layers of folders below the root of the storing unit. That is, the folder of AAAA is provided below the root. The folder of BBBB is provided in the folder of AAAA. The folder of CCCC is provided in the folder of BBBB. In the folder of DDDD, the folder of EEEE is provided. In the folder of EEEE, the information is stored.

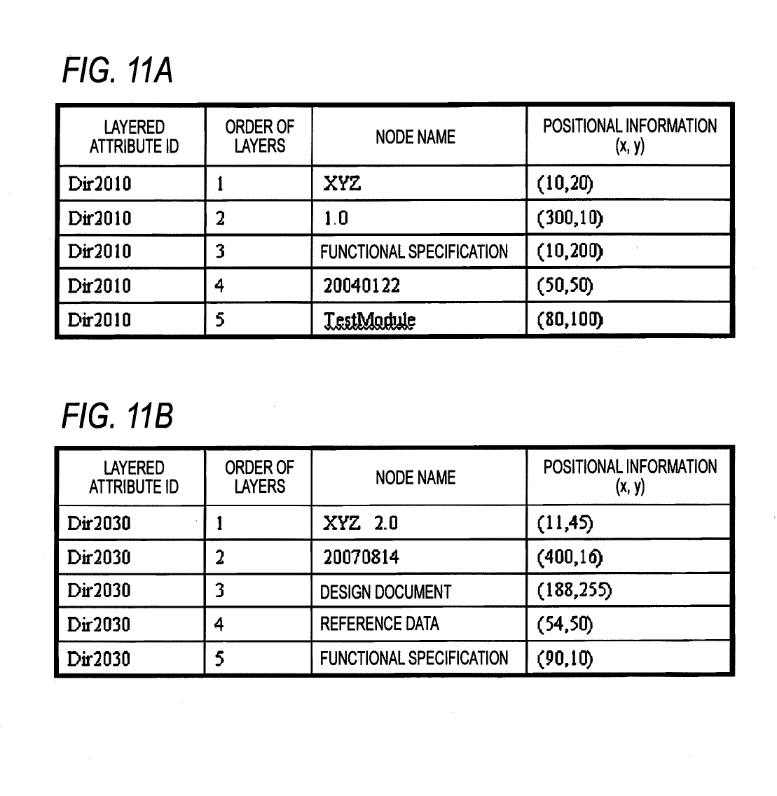

Further, the positional information (X, Y) shows an arrangement coordinate in the window of the node (folder). FIG. 10 is a diagram explaining the positional information. This example exemplifies the positional information of the folder of AAAA. Even when other folder is used, the same result is obtained.

Namely, the positional information indicates X, Y coordinates with a prescribed corner part of the window W as the display frame in which the folder AAAA is arranged taken as an origin. For instance, the central position of the folder AAAA is located at a position of Xa in an X direction (a transverse direction in the drawing) and Ya in an Y direction (a vertical direction in the drawing) from the origin of the window W. This coordinate (Xa, Ya) is set as the positional information of the folder AAAA, that is, the node name of AAAA.

FIG. 9B shows information for managing the electronic file in the server device. The information of the electronic file is managed together with the information of FIG. 9B. In explaining FIG. 9B, the file ID designates an ID issued when the electronic file is registered in the server device. A file name designates the name of the registered electronic file. The layered attribute ID designates an ID showing the layered attribute information of the electronic file. When FIG. 9B is referred to by using the layered attribute ID, the layered attribute information of the electronic file is extracted. In FIG. 9B, one layered attribute ID is set to each file. Further, a plurality of layered attribute IDs are set to coordinate a plurality of layered attribute information together. The plurality of layered attribute information is coordinated together, so that when a plurality of client devices copy the electronic file registered in the server device, a management is carried out at which storing positions the client devices respectively store the electronic file. A server device storing position designates information showing the storing position of the electronic file in the server device. The storing position may be an external device having a storage function.

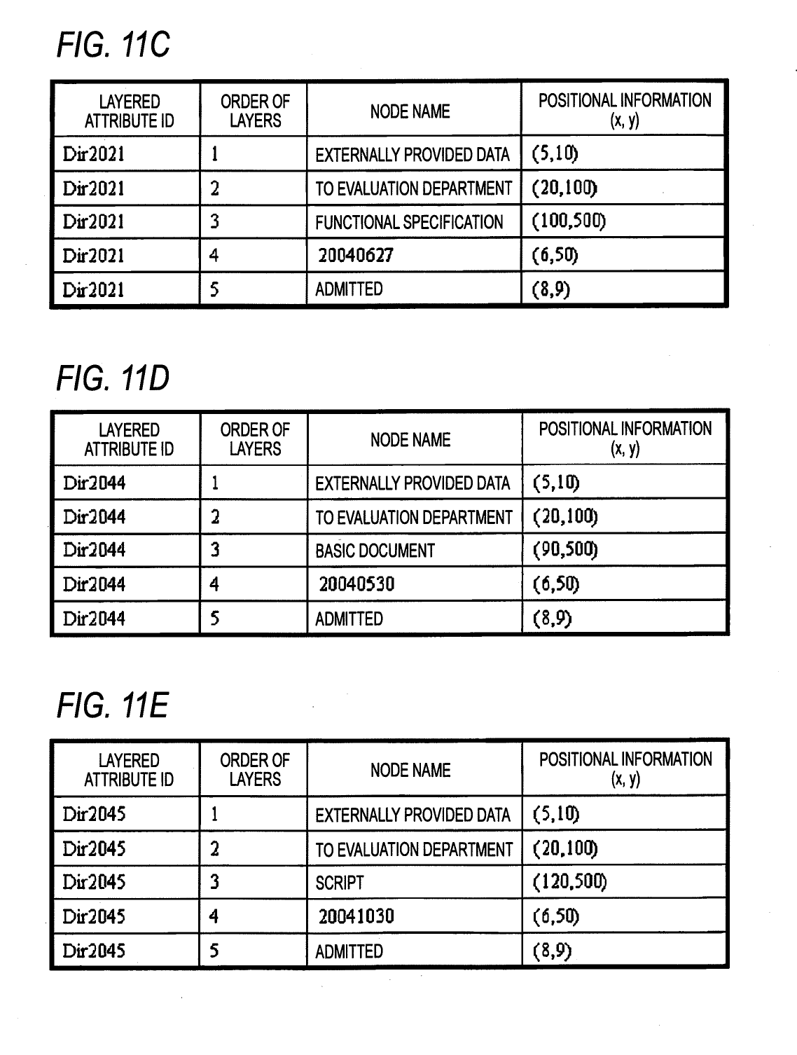

FIGS. 11A to 11E are diagrams showing a specific example of the layered attribute information. FIG. 11A is a diagram showing a specific example of the layered attribute information Ta of the electronic file A stored in the client device 20-1 shown in FIG. 1. Further, FIG. 11B is a diagram showing a specific example of the layered attribute information Tc and Te of the electronic files C and E stored in the client device 20-2 shown in FIG. 1. The layered attribute information Tc and Te has the same contents. Further, FIG. 11C is a diagram showing a specific example of the layered attribute information Tb and Td of the electronic files B and D stored in the client device 20-3 shown in FIG. 1. The attribute information Tb and Td has the same contents. Further, FIG. 11D is a diagram showing a specific example of the layered attribute information Tx of the electronic file X stored in the client device 20-3 shown in FIG. 1. Further, FIG. 11E is a diagram showing a specific example of the layered attribute information Ty of the electronic file Y stored in the client device 20-3 shown in FIG. 1.

In the server device, the electronic files A, B, C, D, E, X and Y from the client devices 20-1 to 20-3 are respectively supposed to be registered under a state that the electronic files are coordinated with the layered attribute information Ta, Tb, Tc, Td, Te, Tx and Ty.

Under the state that the electronic files A, B, C, D, E, X and Y and the layered attribute information Ta, Tb, Tc, Td, Te, Tx and Ty are registered in the server device, the transition of a screen arising when the client device 20-4 shown in FIG. 1 carries out a search process will be described below.

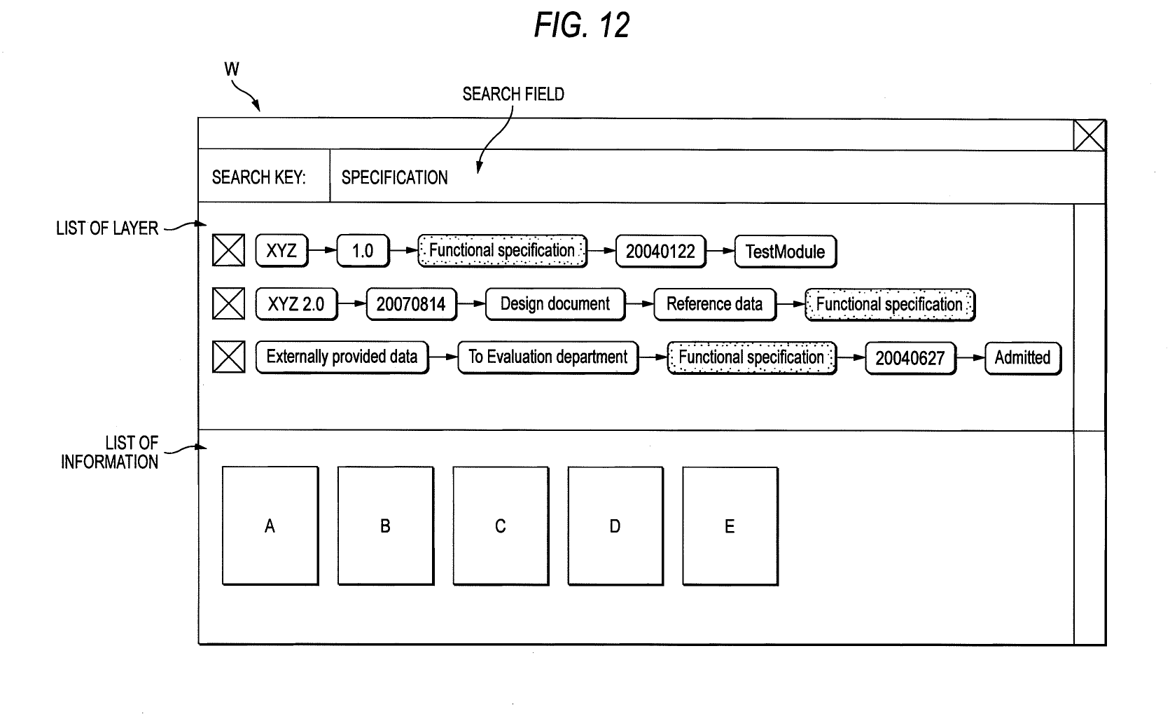

FIG. 12 is a diagram showing the state of the screen arising when the client device carries out the search process. In the screen of the client device that carries out the search process, a window W is displayed that includes the display frames of a search field, a list of layers and a list of information. Here, the user is supposed to input the search word of “specification” in the search field. The search word receiving unit 26 of the client device 20 shown in FIGS. 2A to 2C receives the search word. Then, a search word transmitting unit 27 transmits the search word “specification” to the server device.

The server device 10 shown in FIG. 3 receives the search word “specification” transmitted from the client device to decide whether or not the layered attribute information Ta, Tb, Tc, Td and Te registered in the storing unit includes the “specification” by the search unit 13. Specifically, the server device searches whether or not there is the node name including the search word “specification” in the layered attribute information shown in FIGS. 11A to 11E.

In the examples shown in FIGS. 11A to 11E, the node names of the layered attribute information shown in FIGS. 11A, 11B and 11C have “functional specification” and include the search word “specification”. The server device returns to the client device 20-4, as a searched result, the layered attribute information Ta, Tb, Tc, Td and Te and the names of the electronic files A, B, C, D and E coordinated therewith or corresponding thereto.

The client device 20-4 receives the response from the server device to display the searched result. As shown in FIG. 12, on the screen of the client device 20-4, the layered attribute information Ta, Tb, Tc, Td and Te returned from the server device is displayed in the list of layers of the window W. Here, since the layered attribute information Tc and Te, and the layered attribute information Tb and Td respectively have the same contents, a duplicated display is not carried out.

In the display of the layered attribute information respectively, the node name is displayed in order of layers. The node name including the search word displayed in order of layers is displayed in a different manner from that of other node name (for instance, a dot display or a display in different color).

Further, in the list of information of the window W, the electronic files A, B, C, D and E are displayed that are coordinated with the layered attribute information shown in the above-described list of layers. To the node name of the layered attribute information, may be occasionally attached information necessary for a creator of the electronic file or a person who copies the electronic file to classify the information. In this case, when the search word is included in the node name of the layered attribute information, information related to the search word is extracted. Further, since the node names of the layered attribute information are displayed in order of layers, nodes of the desired layers are traced in order so that desired information is finally detected.

When the user of the client device 20-4 refers to the searched result displayed on the window W to designate an icon (a picture button) of a desired electronic file of the electronic files A, B, C, D and E displayed in the list of information, so that the contents of the electronic file are displayed on the screen.

Further, in the side of the layered attribute information shown in the list of layers of the window W, check boxes CB are displayed. In a first stage, all the check boxes CB are selected. When only a necessary check box CB is selected, only the electronic file coordinated with or corresponding to the layered attribute information of the selected check box CB is displayed on the list of information.

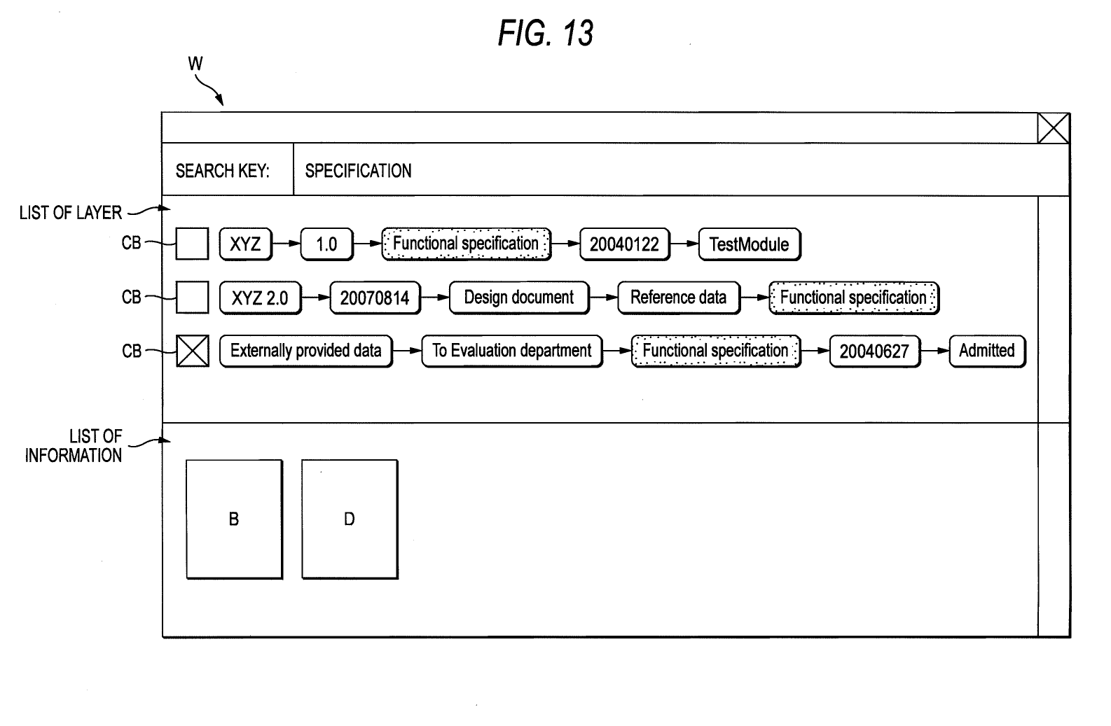

FIG. 13 is a diagram showing a display state appearing when a specific check box is selected. This example shows a state that only the lowest check box CB of three check boxes CB is selected. Thus, only the electronic files B and D coordinated with or corresponding to the layered attribute information of the selected lowest check box CB are displayed on the list of information.

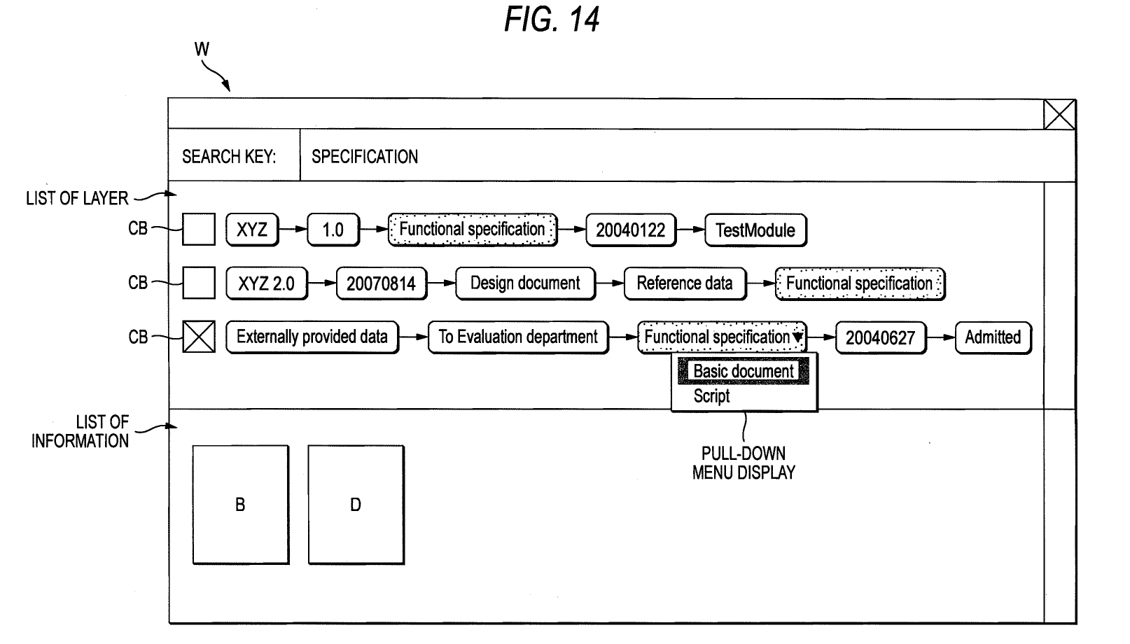

FIG. 14 is a diagram showing a display state appearing when a node having a high relevancy is selected. In the layered attribute information shown in the list of layers of FIG. 14, the layered attribute information shown in the lowest part corresponds to the layered attribute information shown in FIG. 11C. In the node names of the same layer as that of the “functional specification”, the node names “basic document” and “script” of the layered attribute information corresponding to FIGS. 11D and 11E are included. Namely, the “functional specification”, the “basic document” and the “script” have all the same high-order layers (node names) which are included in the same layers.

When a plurality of node names are included in the same layer as described above, a button for selection is displayed in the side of the node name as shown in FIG. 14. For instance, when the button is selected, the list of other node names included in the same layer is displayed in a lower side of the node name (a pull-down menu display). Here, in the pull-down menu display, the node names are displayed in order of positional relation near to the positional Information of an initially displayed node name.

For instance, in an example shown in FIG. 14, the “functional specification” is initially displayed and the “basic document” and the “script” are displayed by the pull-down menu display. In this display, the node name arranged at a position near to the “functional specification” is previously displayed from the positional information of the layered attribute information shown in FIGS. 11C to 11E.

In the layered attribute information shown in FIGS. 11C to 11E, the positional information of the node name “functional specification” of the layered attribute information shown in FIG. 11C indicates (100, 500). Further, the positional information of the node name “basic document” of the layered attribute information shown in FIG. 11D indicates (90, 500). Further, the positional information of the node name “script” of the layered attribute information shown in FIG. 11E indicates (120, 500). Accordingly, linear distances (absolute values) to the positional information (90, 500) of the “basic document” and the positional information (120, 500) of the “script” are calculated by regarding the positional information (100, 500) of the “functional specification) as a reference. The node name whose linear distance is shorter is considered to be located at a position the nearer to the “functional specification” as the reference. Thus, the node names are displayed in such order as described above in the pull-down menu display.

In the example shown in FIGS. 11C to 11E, since the linear distance of the “basic document” is 10 and the linear distance of the “script” is 20 by regarding the positional information (100, 500) of the “functional specification” as the reference, the pull-down menu display is carried out in order of the “basic document” and the “scrip” from a part having the linear distance shorter from the positional information of the “functional specification”. In a plurality of nodes (folders) located in the same layer, the nodes having higher relevancy to each other may be arranged at positions the nearer to each other. Accordingly, when the nodes are displayed in order of near distance, the nodes are displayed to be selected in order of high relevancy.

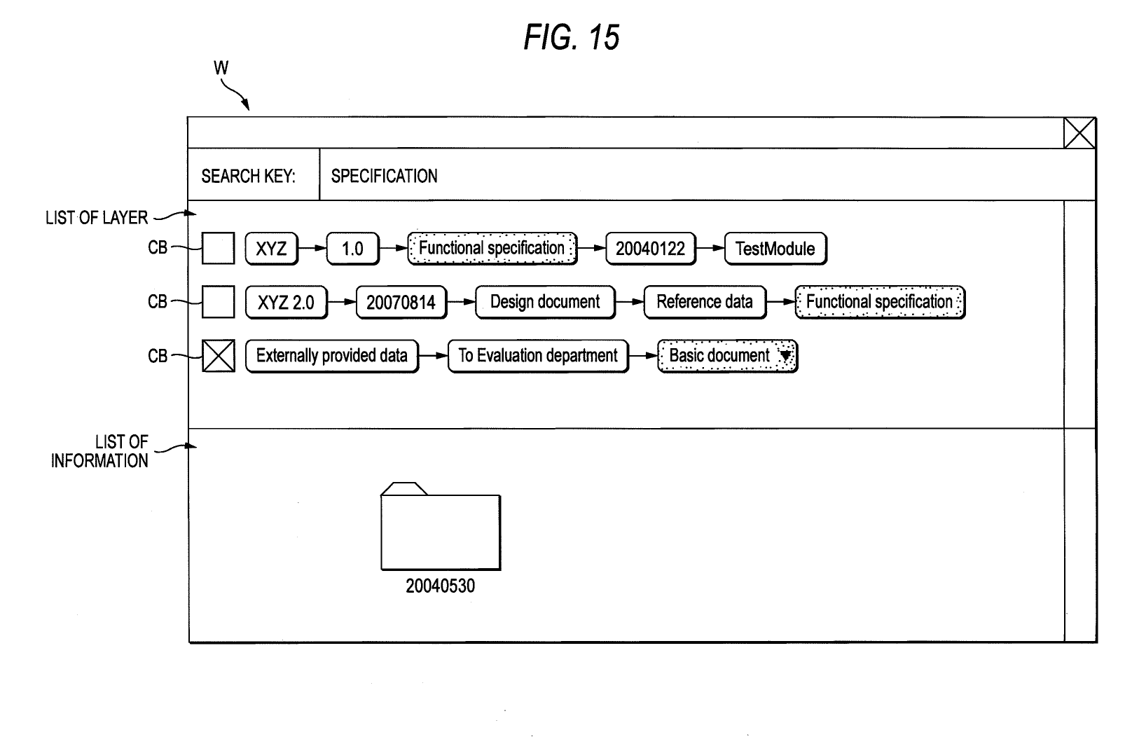

FIG. 15 is a diagram showing a display state appearing when one is selected from the pull-down menu display shown in FIG. 14. Here, a case is shown as an example that the “basic documents” is selected from the pull-down menu display shown in FIG. 14. When other node name is selected in such a way, a node (folder) included in that node (folder) is displayed in the list of information. In the example shown in FIG. 15, the folder of 20040530 as the node (folder) included in the node name “basic document” in FIG. 11D is displayed by an icon together with the node name (folder name)

When the user selects the icon display of the folder in the list of information, the node or information included in the folder is displayed in the list of information. For instance, when the electronic file X is stored in the folder of 20040530, if the icon display of the folder of 20040530 is selected, the electronic file X is displayed in the list of information.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An information processor, comprising:
a layered attribute obtaining unit that obtains layered attribute information related to a storing position where an electronic file is stored; and
a transmitting unit that transmits the layered attribute information obtained by the layered attribute obtaining unit to an electronic file managing device together with the electronic file, the electronic file managing device managing the electronic file.

2. The information processor according to claim 1, further comprising:
an attribute information managing unit that manages address information of the electronic file managing device to which the electronic file is transmitted by the transmitting unit,
wherein, when the storing position of the electronic file is changed, the layered attribute obtaining unit obtains new layered attribute information related to the changed storing position, and
the transmitting unit transmits the new layered attribute information obtained by the layered attribute obtaining unit to the electronic file managing device in accordance with the address information managed by the attribute information managing unit.

3. An information processor, comprising;
a receiving unit that receives an electronic file stored in an electronic file managing device, the electronic file managing device managing the electronic file;
a layered attribute obtaining unit that obtains layered attribute information related to a storing position where the electronic file received by the receiving unit is stored; and
a transmitting unit that transmits the layered attribute information to the electronic file managing device so as to register the layered attribute information obtained by the layered attribute obtaining unit based on information of the electronic file managing device in which the received electronic file is stored.

4. An information processor, comprising:
a receiving unit that receives a search word, wherein an electronic file is managed by an electronic file managing device and the managed electronic file is searched by using the search word;
a transmitting unit that transmits the search word received by the receiving unit to the electronic file managing device; and
a searched result display unit that displays layered attribute information as a searched result received from the electronic file managing device, wherein the attribute information is related to a storing position of the electronic file including the search word.

5. An electronic file managing device, comprising:
a receiving unit that receives an electronic file and layered attribute information related to a storing position of the electronic file, the electronic file being transmitted from an information processor;
an electronic file managing unit that coordinates the electronic file and the layered attribute information received by the receiving unit and that manages the electronic file and the layered attribute information received by the receiving unit;
a search unit, wherein when a search word is transmitted from the information processor, the search unit searches whether or not the layered attribute information managed in the electronic file managing unit includes the search word; and
a transmitting unit,
wherein, in a case where layered attribute information including the search word is detected as a result of a search by the search unit, the transmitting unit transmits the layered attribute information and information related to the electronic file coordinated with the layered attribute information to the information processor, and
in a case where layered attribute information including the search word is not detected, the transmitting unit transmits an effect that there is no layered attribute information including the search word to the information processor.

6. An electronic file managing system comprising;
an electronic file managing device that manages an electronic file; and
an information processor, the electronic file managing device and the information processor being connected together through a communication line,
the information processor including:
a layered attribute obtaining unit that obtains layered attribute information related to a storing position of the electronic file while the electronic file is registered in the electronic file managing device; and
a transmitting unit that transmits the layered attribute information obtained by the layered attribute obtaining unit to the electronic file managing device together with the electronic file, and
the electronic file managing device including:
a receiving unit that receives the electronic file and the layered attribute information of the electronic file transmitted from the transmitting unit of the information processor;
an electronic file managing unit that coordinates the electronic file and the layered attribute information received by the receiving unit and that manages the electronic file and the layered attribute information received by the receiving unit;
a search unit, wherein when a search word is transmitted from the information processor, the search unit searches whether or not the layered attribute information managed in the electronic file managing unit includes the search word; and
a transmitting unit,
wherein, in a case where layered attribute information including the search word is detected as a result of a search by the search unit, the transmitting unit transmits the layered attribute information and information related to the electronic file coordinated with the layered attribute information to the information processor, and
in a case where layered attribute information including the search word is not detected, the transmitting unit transmits an effect that there is no layered attribute information including the search word to the information processor.

7. A computer readable medium storing a program causing a computer to execute a process for managing an electronic file, the process comprising:
obtaining layered attribute information related to a storing position of an electronic file stored; and
transmitting the obtained layered attribute information to an electronic file managing device together with the electronic file, the electronic file managing device managing the electronic file.

8. A computer readable medium storing a program causing a computer to execute a process for managing an electronic file, the process comprising:
receiving a search word, wherein an electronic file is managed by an electronic file managing device and the managed electronic file is searched by using the search word;
transmitting the received search word to the electronic file managing device through a communication line; and
displaying layered attribute information related to a storing position of the electronic file including the search word as a searched result received from the electronic file managing device.

9. A computer readable medium storing a program causing a computer to execute a process for managing an electronic file, the process comprising:
receiving an electronic file and layered attribute information related to a storing position of the electronic file, wherein the electronic file is transmitted from an information processor through a communication line;
coordinating the received electronic file and the received layered attribute information of the electronic file
managing the received electronic file and the received layered attribute information of the electronic file received;
searching whether or not the managed layered attribute includes a search word, when the search word is transmitted from the information processor;
transmitting the layered attribute information and information related to the electronic file coordinated with the layered attribute information to the information processor, when layered attribute information including the search word is detected as a result of a search; and
transmitting an effect that there is no layered attribute information including the search word to the information processor, when layered attribute information including the search word is not detected.
